(19) United States
(12) Patent Application Publication
(10) Pub. No.: US 2010/0118397 A1
(43) Pub. Date: May 13, 2010

(54) Reduced Laser Speckle Projection Screen

(75) Inventors: Karlton D. Powell, Lake Stevens, WA (US); Randall B. Sprague, Hansville, WA (US)

Correspondence Address: MICROVISION, INC., 6222 185TH AVENUE NE, REDMOND, WA, 98052, US

(73) Assignee: Microvision, Inc., Redmond, WA (US)

(21) Appl. No.: 12/268,863

(22) Filed: Nov. 11, 2008

(51) Int. Cl. G03B 21/60

(52) U.S. Cl. 359/452

(57) ABSTRACT

A projection screen reduces laser speckle. Cells having non-zero volume are arranged on the projection screen so as to receive laser light. The cells are at least partially filled with a light scattering media. The laser light enters the cells and is spatially scattered. The light emerging from the cells includes many phase fronts with a more random polarization state. Speckle is reduced as a result. The cells are oriented to reduce lateral movement of light from one cell to another, thereby reducing blooming that would otherwise occur.

### BACKGROUND

Laser light beams are finding uses in a wide variety of applications. For example, scanning laser light beams may be used in display applications such as mobile microprojectors, automotive head-up displays, and head-worn displays. The laser light is typically projected on a display surface. Depending on the type of display surface, the reflected laser light may include an observable phenomenon commonly referred to as “speckle.”

Speckle is caused by interference patterns in the reflected laser light. Laser light typically has high spatial and temporal coherence. After being scattered off a display surface, the reflected light displays an interference pattern that appears as bright spots (speckle).

Speckle can be reduced by adding diffusive material to the display surface. Diffusive material on the display surface causes light to be scattered at much greater angles, thereby reducing the deterministic interference pattern and the resulting speckle. Although diffusive material on a display surface can be useful for speckle reduction, the greater scattering angles also cause the reflected laser spot to appear much larger. This phenomenon is referred to as “blooming” and can result in a reduction in image resolution.

Accordingly, the use of diffusive display surfaces for speckle reduction typically involves a trade-off between speckle reduction and image resolution.

### BRIEF DESCRIPTION OF THE DRAWINGS

FIG. 1 shows a laser projector projecting light on a reduced laser speckle projection screen in accordance with various embodiments of the present invention;

FIG. 2 shows a cross-section of a reduced laser speckle projection screen with light scattering media;

FIG. 3 shows a cross-section of a reduced laser speckle projection screen with light scattering media with a dimpled surface;

FIG. 4 shows a cross-section of a reduced laser speckle projection screen with light scattering media and a laminated diffuser;

FIG. 5 shows a cross-section of a reduced laser speckle projection screen with a wire mesh, light scattering media, and a laminated diffuser;

FIG. 6 shows a cross-section of a reduced laser speckle projection screen having parabolic cells partially filled with light scattering media;

FIG. 7 shows a cross-section of a reduced laser speckle projection screen having collimated cells filled with light scattering media;

FIG. 8 shows a cross-section of a transmissive reduced laser speckle projection screen having collimated holes filled with light scattering media; and

FIG. 9 shows various projection screen cell layouts in accordance with various embodiments of the present invention.

### DESCRIPTION OF EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

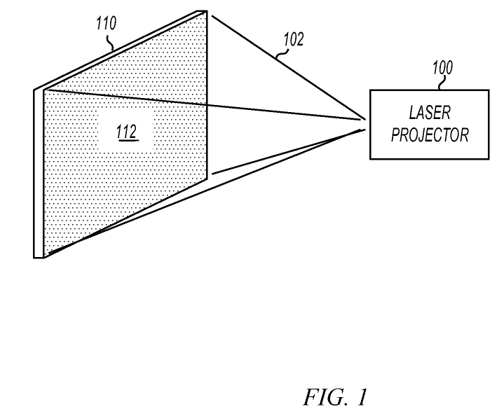

FIG. 1 shows a laser projector projecting light on a reduced laser speckle projection screen in accordance with various embodiments of the present invention. Laser projector 100 projects laser light 102 on surface 112 of screen 110. Laser projector 100 may be any type of laser projector, including for example, a scanned-beam laser projector, a scanned one-dimensional (ID) array laser projector, or an imaged two-dimensional (2D) panel laser projector. Any type of laser projection system can be used to project laser light on screen 110 without departing from the scope of the present invention.

Surface 112 includes cavities or “cells” that include a light scattering media. The light scattering media causes the laser light to scatter randomly within the cells and to emerge with many different phase fronts at various angles. As the phase fronts combine, apparent speckle is reduced. Each of the cells includes cell walls that keep light from propagating to adjacent cells, and this reduces blooming. The cell walls may be reflective or absorptive. Further, the cells may be only partially or completely filled with the light scattering media.

The cells may be any shape, and may be arranged in any pattern. For example, when viewed from above the surface, the cells may be hexagonal, circular, triangular, or any other shape. When viewed in cross-section, the cells may be formed as cups, parabaloids, hemispheres, cylinders, or any other shape. Various embodiments having different cell shapes are described further below.

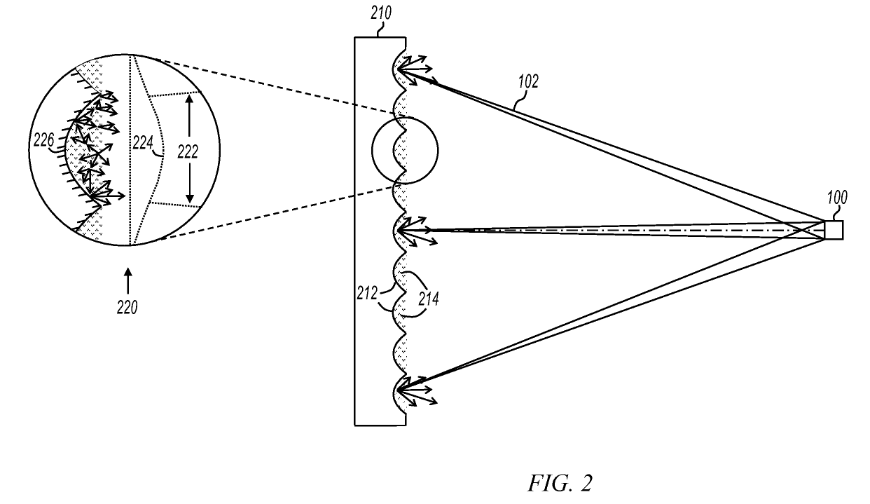

FIG. 2 shows a cross-section of a reduced laser speckle projection screen with light scattering media. Reduced laser speckle projection screen 210 is shown having laser light 102 projected thereon. Projection screen 210 includes cells 212 formed on one surface. Cells 212 have non-zero volume, and are at least partially filled with light scattering media 214.

Laser light entering light scattering media 214 is spatially scattered to create different randomly oriented and polarized phase fronts such that no clean cut wavefront is associated with the output light from any given cell. This is shown in more detail in view 220, where the light rays are shown being randomly scattered in cell 226.

Cells 212 are separated by cell walls to keep light from propagating to adjacent cells. In some embodiments the cell walls may be black absorbing (less efficient) or highly reflective (most efficient). Also, cells 212 may be any size and shape. For example, cells 212 in FIG. 2 are formed as indentations, or “cups”, in one surface of screen 210. These cups may be arranged in rows and columns to form a regular array, or may be arranged in a random or pseudo-random pattern. Reduction of apparent speckle may be achieved when cell structure profile, cell layout, sag depth, and sparseness and density of light scattering media are adjusted by design to allow light to scatter into and illuminate all portions of a cell's volume before exiting toward a viewer.

Light scattering media 214 may be any type of media that scatters light to reduce laser speckle. For example, in some embodiments, silicone based materials are used as light scattering media 214. White room temperature vulcanizing (RTV) silicone rubber has been found to function well as a light scattering media due to its fineness and homogeneity. Also for example, in some embodiments, fine grain particulate having a particle size significantly small compared to cell size may be used. The particulate may be mixed with a transparent epoxy carrier to form light scattering media 214. Also for example, colloidal suspensions and nanoparticles may also make good candidates for the light scattering media. In some embodiments, light scattering media 214 includes some amount of attenuating dye for trading brightness with some degree of apparent ambient rejection.

The size of cells 212 may be chosen based on the size of the laser spot size expected to be incident upon screen 210. For example, in some embodiments, the cell diameter is chosen to be smaller than the laser spot size. This case is illustrated in detail view 220. The laser spot distribution is shown at 224. This laser spot illuminates cell 226 and to a lesser extent, the adjacent cells. The light emerging from cell 226 occupies cone 222. In this example, the laser spot is able to span a few cells at once. Light exiting each cell will bloom to a full cell size, similar to that shown at 220, effectively causing the spot size to grow by a factor of three. In some embodiments, the cell diameter is much smaller than the laser spot. In these embodiments, the blooming is reduced because each adjacent cell is smaller. In the limit, with an infinitely small cell size, blooming would be eliminated, although infinitely small cell size is not practical. In a practical system, the cells may be sized so that a few to tens or hundreds of cells can be illuminated by the laser spot at once.

By creating an array of cells with volumetric light scattering qualities across a surface of the screen, speckle reduction is achieved while maintaining apparent resolution of the projection display on the screen as seen by the viewer. For simplicity of illustration, the profile of projection screen 210 is shown having just a few cells. In practice, projection screens may have many millions of cells. Further, in some alternate embodiments, “cells” may be formed using reflective faceted granules on the order of cell size and slightly smaller. These granules may be mixed with the light scattering media to achieve a similar effect of limiting blooming without a fixed array structure, depending on mix density and faceted reflective grain shape.

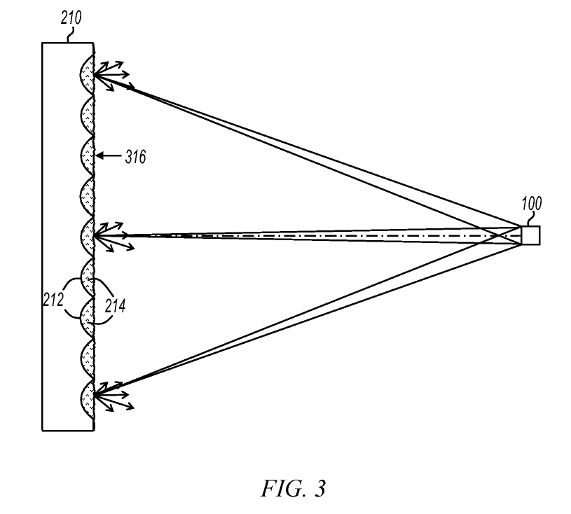

FIG. 3 shows a cross-section of a reduced laser speckle projection screen with light scattering media with a dimpled surface. In embodiments represented by FIG. 3, light scattering media 214 includes a dimpled surface 316. The dimpled surface may be formed during manufacture when the light scattering media is deposited.

If the surface 316 is left flat and specular (e.g., not dimpled), Fresnel reflections (a few percent of input beam light) off the surface results in a hot-spot appearing in the display field of view (FOV) to the viewer, depending on the viewer's position. The pixel location within the FOV is defined by the scanned-beam angular position which exhibits an angle-of-incidence (AOI) such that that beams' light reflects at an angle of reflection so as to enter the viewer's eye. Anti-reflective (AR) coating may help diminish the effect, but may still allow some percentage of light reflection. By molding a dimpled surface onto the light scattering media with no extent beyond the cell extent, even this Fresnel reflected light can be scattered so as to mitigate hot-spot reflections. Further, this molded dimpled-relief surface can be AR-coated, as needed.

The dimpled surface 316 further reduces speckle that would otherwise result from specular reflection off a smooth surface. Although much of the incident laser light enters the light scattering media as described above with reference to FIG. 1, some of the light will also reflect off the surface of the light scattering media. By creating a non-specular (dimpled) surface, speckle is further reduced.

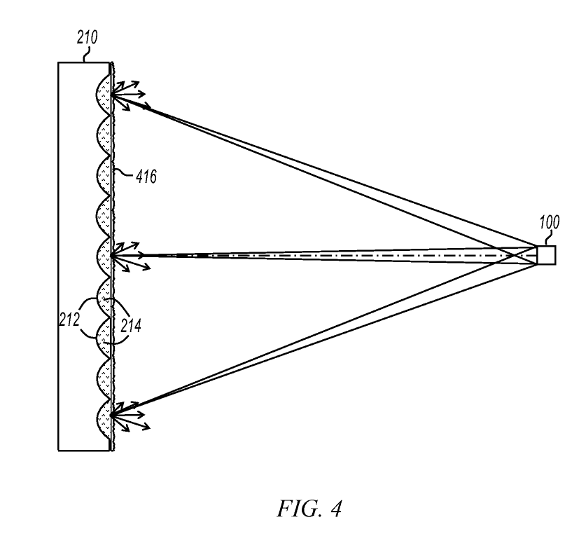

FIG. 4 shows a cross-section of a reduced laser speckle projection screen with light scattering media and a laminated diffuser. Laminated diffuser sheet 416 is included to encase the light scattering media 214. In embodiments without a laminated diffuser sheet 416, some light scattering media may protrude beyond the cell structures that are designed to limit blooming. Light scattering will then occur outside the cells, and blooming will increase.

Lamination can help achieve consistent fill of the light scattering media; however, an optically smooth sheet will cause specular reflection of the projected light causing a ‘hot spot’ to appear at some location on the screen due to position of the viewer and the position of the projector. AR-coating can diminish this specular reflection of the projected light, but use of a random surface relief diffuser can help scatter this initial reflected light. Further, in some embodiments, the diffuser outer surface can also be AR-coated.

Laminated diffuser sheet 416 is shown having a specular flat surface and a randomly dimpled surface. The specular flat back surface is in contact with light scattering media 214, and the randomly dimpled surface is on the side opposite the light scattering media. The randomly dimpled surface reduces specular reflection, and further reduces speckle. In some embodiments, the randomly dimpled surface is also AR-coated.

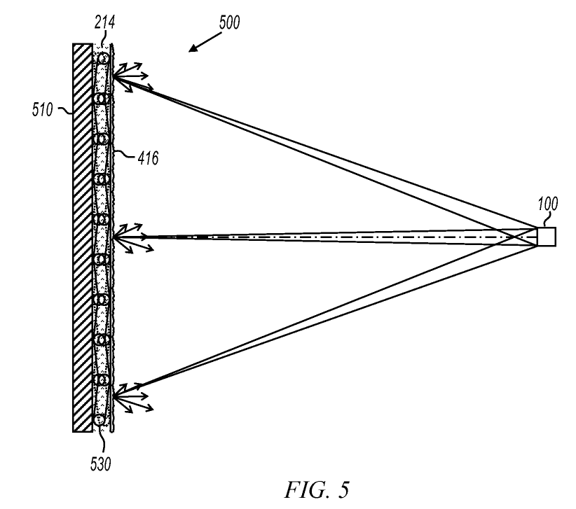

FIG. 5 shows a cross-section of a reduced laser speckle projection screen with a wire mesh, light scattering media, and a laminated diffuser. Projection screen 500 includes backing 510, wire mesh 530, light scattering media 214, and laminated diffuser sheet 416. The light scattering media 214 envelops the wire mesh and is encased by the laminated diffuser sheet. Cells are created by the holes in wire mesh 530.

In some embodiments, wire mesh 530 is a commonly available sieve mesh. In these embodiments, wire mesh 530 includes a non-zero displacement on the axis orthogonal to backing 510 (the z axis). The wire mesh displacement on the z-axis causes some degradation of performance due to loss in ideal containment of blooming, but such a screen has been fabricated and exhibits improved sharpness and reduced speckle as compared with paper.

In other embodiments, wire mesh 530 is formed by perforating a metal sheet. In these embodiments, wire mesh 530 does not include a displacement in the z-axis, and blooming is more effectively controlled. The perforated mesh may provide optical advantages over a sieve mesh, but may also be more difficult to fabricate in extremely small cell sizes.

In some embodiments, projection screen 500 is flexible enough to be rolled up. In these embodiments, the wire mesh 530 and light scattering media 214 are encased between an extremely thin reflective backing 510 and laminated diffuser sheet 416.

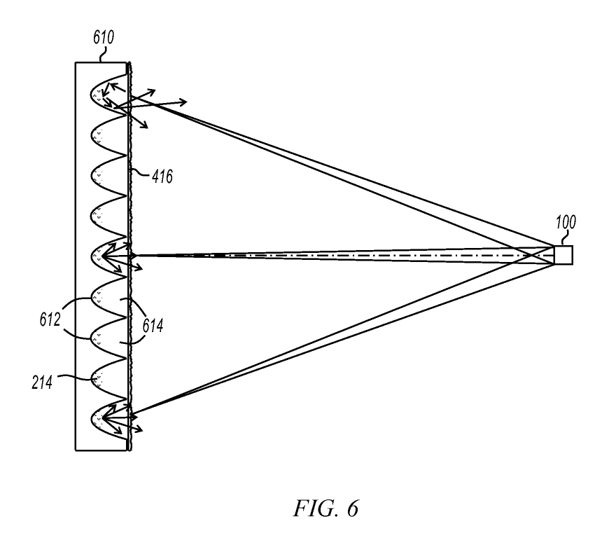

FIG. 6 shows a cross-section of a reduced laser speckle projection screen having parabolic cells partially filled with light scattering media. Projection screen 610 includes cells 612 having parabolic cross-sections. In some embodiments, cells 612 have parabolic cross-sections regardless of the cross-section taken. In other embodiments, cells 612 have a parabolic cross-section on one axis, and a non-parabolic cross-section on a different axis.

Cells 612 are partially filled with light scattering media 214. The remaining volume of cells 612 is filled with transparent filler media 614, and then diffuser sheet 416 is laminated over the cells and the media. When laser light enters at low angles, the light spreads all around in diffuser, bounces off the cell walls and leaves at high angles of scatter. This will cause angular spread on the exit cone. Higher exit angles may be acceptable based on the application.

In some embodiments, cells 612 are completely filled with light scattering media 214, and no transparent fill media is used. In other embodiments, the transparent fill media 614 includes a randomly dimpled surface, and diffuser sheet 416 is omitted. In still further embodiments, cells 612 are partially filled with light scattering media 214, and transparent fill media 614 and diffuser sheet 416 are omitted. Any of the embodiments described herein may have cells partially filled with media or completely filled with media. Further, any of the embodiments described herein may include a laminated diffuser sheet or may omit a laminated diffuser sheet. Still further, any of the embodiments described herein may include a non-specular or dimpled surface, either formed in media or on a diffuser sheet.

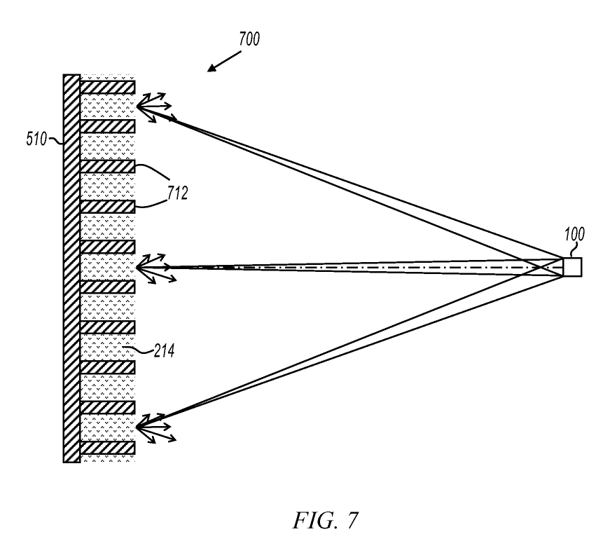

FIG. 7 shows a cross-section of a reduced laser speckle projection screen having collimated cells filled with light scattering media. Screen 700 is formed by backing 510, cell walls 712, and light scattering media 214. In some embodiments, the cells are cylindrical, however, this is not a limitation of the present invention. For example, the cells may also be hexagonal, square, rectangular, linear (for effect in ID), etc. Further, the cell layout grid may be hexagonal, square, rectangular, linear, etc.

Backing 510 and cell walls 712 may be made of any suitable material. For example, a molded polymer material, plastic, glass, or a fibrous paper material may be used. Screen 700 may be manufactured on a rolled process in which a grooved drum forms cell walls 712 through extrusion. The various embodiments of the present invention are not limited by the method of fabrication.

The cells of screen 700 may be completely filled or partially filled with light scattering media 214. In some embodiments, ambient light rejection is increased by partially filling non-reflective cells. In these embodiments, ambient light arriving at high angles is absorbed prior to entering the light scattering media, whereas projected laser light arriving at lower angles enters the light scattering media and is scattered in accordance with the descriptions provided above.

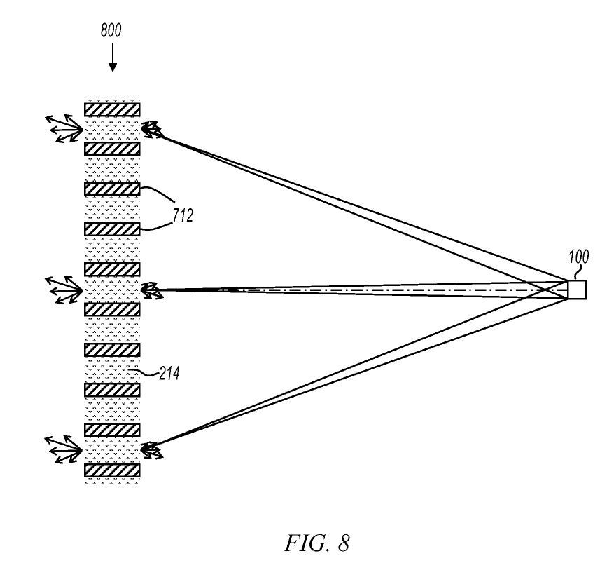

FIG. 8 shows a cross-section of a transmissive reduced laser speckle projection screen having collimated holes filled with light scattering media. Screen 800 corresponds to screen 700 (FIG. 7) without backing 510. Without the backing, the cells of screen 700 become holes in screen 800.

The holes in screen 800 are partially or completely filled with light scattering media 214. Screen 800 is a transmissive version of screen 700, which is reflective. Any of the screen embodiments described herein may be transmissive screens or reflective screens. For example, transmissive screens may include dimpled surfaces, either on media or diffusers. Further, transmissive screens may include diffusers on one or two sides of the screens.

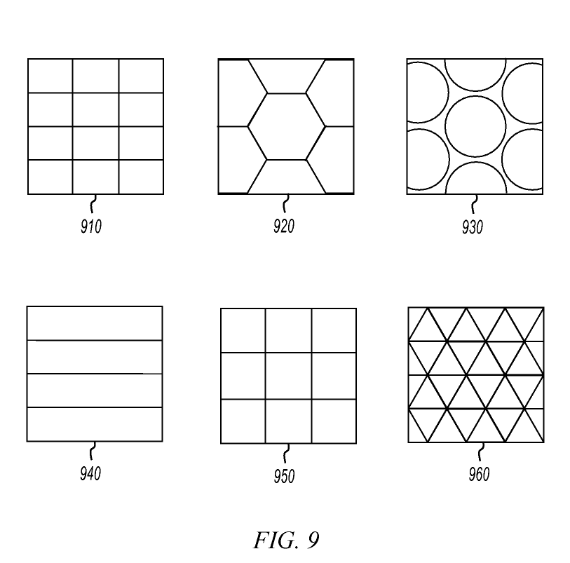

FIG. 9 shows various projection screen cell layouts in accordance with various embodiments of the present invention. The cell layouts shown in FIG. 9 correspond to cell layout patterns on a screen surface such as screen surface 112 (FIG. 1).

Cells may be laid out in a rectangular grid 910, a square grid 950, or a triangular grid 960. Cells may also be laid out in a hexagonal pattern 920 or as circles 930. Cells may also be one dimensional as shown at 940. The layout patterns shown in FIG. 9 are examples, and the various embodiments of the invention are not limited to the patterns shown. For example in some embodiments, cells are laid out in a random pattern, and in other embodiments, cells are laid out in a pseudo-random pattern.

Any of the possible layout patterns may be combined with any of the cell cross-sections. For example, cells laid out in accordance with rectangular grid 910 may be shaped as cups, hemispheres, parabolas, or any other shape. Also for example, any of the possible cell layouts may be used with reflective screens or transmissive screens.

Linear cell arrays (940) may be formed by linear extension of any of the disclosed cell profiles, including rows of wires or micro-rods. For example, cells may be formed by walls in only one dimension such that each cell forms a strip either horizontally or vertically on the screen. Blooming still occurs in one dimension, but this may be outweighed by manufacturing benefits. For example, the horizontal direction may be left free to bloom, but an inexpensive rolled manufacturing process could be used to build the screen.

In some embodiments, a linear array of triangular facets (similar to brightness enhancement film) may also be used. Array of hollow corner-cube cavities may also be used as a cell structure, possibly in combination with triangular cells with alternating orientation.

Although the present invention has been described in conjunction with certain embodiments, it is to be understood that modifications and variations may be resorted to without departing from the scope of the invention as those skilled in the art readily understand. Such modifications and variations are considered to be within the scope of the invention and the appended claims.

What is claimed is:

1. A projection screen having a plurality of cells with non-zero volume at least partially filled with light scattering media, each of the plurality of cells being oriented to receive light projected onto the screen and to keep the light from propagating to adjacent ones of the plurality of cells.

2. The projection screen of claim 1 wherein each of the plurality of cells are shaped as hexagons.

3. The projection screen of claim 1 wherein the plurality of cells are formed as cups.

4. The projection screen of claim 1 wherein the plurality of cells each have is parabolic cross-sections.

6. The projection screen of claim 1 wherein the plurality of cells each have hemispherical cross-sections.

7. The projection screen of claim 1 wherein the plurality of cells are randomly placed across the projection screen.

8. The projection screen of claim 1 wherein the light scattering media includes silicone.

9. The projection screen of claim 1 wherein the light scattering media includes room temperature vulcanizing (RTV) silicone rubber.

10. The projection screen of claim 1 wherein the light scattering media includes a fine grain particulate.

11. The projection screen of claim 10 wherein the light scattering media includes an epoxy to hold the fine grain particulate.

12. The projection screen of claim 1 wherein the plurality of cells include cell walls to reflect the light.

13. The projection screen of claim 1 wherein the plurality of cells include cell walls to absorb the light.

14. The projection screen of claim 1 wherein the plurality of cells are only partially filled with the light scattering media.

15. The projection screen of claim 1 wherein the plurality of cells are completely filled with the light scattering media.

16. The projection screen of claim 15 further comprising a light diffusive layer laminated to the plurality of cells such that the light scattering media is encased between the plurality of cells and the light diffusive layer.

17. The projection screen of claim 16 wherein the light diffusive layer includes a first surface that faces the plurality of cells, the first surface being reflective.

18. The projection screen of claim 17 wherein the light diffusive layer includes a second surface opposite the first surface, the second surface being non-reflective.

19. A projection screen comprising:
a substantially planar surface;
a three dimensional structure coupled to the substantially planar surface, the three dimensional structure forming a plurality of cells having non-zero volume; and
a light scattering media at least partially filling the plurality of cells.

20. The projection screen of claim 19 wherein the plurality of cells include reflective cell walls to contain light from traveling to adjacent ones of the plurality of cells.

21. The projection screen of claim 19 wherein the plurality of cells include absorptive cell walls to contain light from traveling to adjacent ones of the plurality of cells.

22. The projection screen of claim 19 wherein the three dimensional structure comprises a wire mesh.

23. A projection screen comprising:
a plurality of cells having non-zero volume oriented to receive light projected upon the projection screen; and
light scattering media at least partially filling the non-zero volume of the plurality of cells.

24. The projection screen of claim 23 wherein the plurality of cells receive the light on a first side of the projection screen, the projection screen further comprising a reflective backing on a second side.

25. The projection screen of claim 23 wherein the plurality of cells are open on two sides of the projection screen to allow the light to be received on a first of the two sides and exit on a second of the two sides.
